(19) United States
(12) Patent Application Publication
(10) Pub. No.: US 2019/0078544 A1
(43) Pub. Date: Mar. 14, 2019

(54) Fuel Rail Assembly

(71) Applicant: Continental Automotive GmbH, Hannover (DE)

(72) Inventors: Gisella Di Domizio, San Giuliano Terme (IT); Marco Pasquali, Livorno (IT); Giandomenico Serra, Ghezzano-S. Giuliano Terme (PI) (IT)

(73) Assignee: Continental Automotive GmbH, Hannover (DE)

(21) Appl. No.: 15/762,777

(22) PCT Filed: Sep. 21, 2016
(86) PCT No.: PCT/EP2016/072468

§ 371 Date: Mar. 23, 2018

(30) Foreign Application Priority Data
Sep. 24, 2015 (EP) 15186715.7

(51) Int. Cl. F02M 55/02; F02M 55/00; F02M 61/14; F02M 63/02; F02M 69/46; F02M 61/16

(52) U.S. Cl. CPC F02M 55/025; F02M 55/005; F02M 61/14; F02B 2075/125; F02M 69/465; F02M 61/168; F02M 55/002; F02M 63/025

(57) ABSTRACT

Various teachings of the present disclosure may be embodied in a fuel rail assembly for a combustion engine comprising: an elongated tubular fuel rail; a fuel delivery pipe unit hydraulically coupled to the fuel rail; an injector cup for receiving a fuel injector, a pipe coupled to the cup and to the rail, and at least one fixation unit for fixing the pipe unit to the engine. The fixation unit comprises a connecting element fixed to a predetermined pipe unit portion by a first filler material joint. The connecting element, absent the first filler material joint, is axially and rotatably movable relative to the pipe and the injector cup. The fixation unit includes a bracket element with a through hole for a bolt to the engine. The bracket element is fixed to a predetermined connecting element portion by a second filler material joint. The bracket element, absent the second filler material joint, is laterally movable with respect to the connecting element for adjusting its radial distance from the pipe and the injector cup.

### CROSS-REFERENCE TO RELATED APPLICATIONS

This application is a U.S. National Stage Application of International Application No. PCT/EP2016/072468 filed Sep. 21, 2016, which designates the United States of America, and claims priority to EP Application No. 15186715.7 filed Sep. 24, 2015, the contents of which are hereby incorporated by reference in their entirety.

### TECHNICAL FIELD

The present disclosure relates to internal combustion engines. Various teachings thereof may be embodied in a fuel rail assembly for a combustion engine and/or a method for manufacturing a fuel rail assembly.

### BACKGROUND

Fuel rail assemblies for combustion engines are in widespread use, in particular for internal combustion engines. A typical fuel rail assembly includes a fuel rail. A plurality of fuel injectors may be connected to the fuel rail. The fuel rail may also be called a common rail. The fuel rail assembly may be coupled to a cylinder head of a combustion engine. The fuel rail may comprise a hollow body with recesses to act as fuel injector cups. Alternatively, fuel injector cups may be coupled to the fuel rail by pipes. The injector cups are for receiving the fuel injectors. The fuel rail serves as a fuel accumulator to supply fuel to the internal combustion engine through the fuel injectors. The fuel rail may also act to keep pressure fluctuations during the operation of the internal combustion engine at a sufficiently low level.

EP 2910768 A1 discloses a fuel rail assembly for an internal combustion engine which comprises an elongated fuel rail, a plurality of injector cups for hydraulically coupling the fuel rail assembly to respective fuel injectors and a pipe assigned to each injector cup for hydraulically coupling the respective injector cup to the fuel rail. Each pipe comprises an upper tube and a lower tube. A fixation bracket is assigned to each pipe which is configured for positionally fixing the fuel rail assembly with respect to the combustion engine and is rigidly connected to the respective lower tube. A rigid connection is established between a downstream end section of the upper tube and an upstream end section of the lower tube. The downstream end section of the upper tube and the upstream end section of the lower tube are in engagement with one another in such fashion that, absent the rigid connection, the upper tube and the lower tube are rotatable with respect to one another around a predetermined rotational axis.

### SUMMARY

The teachings of this disclosure may enable a fuel rail assembly which is in particularly easily adaptable for differently shaped engines and/or a method for manufacturing a cost-efficient fuel rail assembly. For example, a fuel rail assembly (20) for an combustion engine may comprise an elongated tubular fuel rail (4) and at least one fuel delivery pipe unit being hydraulically coupled to the fuel rail (4). The fuel delivery pipe unit may comprise an injector cup (3) for receiving a fuel inlet portion of a fuel injector, a pipe (2) being hydraulically coupled to the injector cup (3) and to the fuel rail (4), and at least one fixation unit for fixing the fuel delivery pipe unit to the combustion engine. In some embodiments, the fixation unit comprises a connecting element fixedly connected to a predetermined pipe unit portion by a first filler material joint. In some embodiments, the connecting element (6), absent the first filler material joint, is axially and rotatably movable relative to the pipe (2) and the injector cup (3) with respect to a longitudinal axis (L) of the pipe (2). In some embodiments, there is a bracket element (1) comprising a through hole (10) for receiving a fixation bolt which is provided for fixing the bracket element (1) to the engine, the bracket element (1) being fixedly connected to a predetermined connecting element portion by a second filler material joint. The bracket element (1), absent the second filler material joint, is laterally movable with respect to the connecting element (6) for adjusting its radial distance from the pipe (2) and the injector cup (3).

In some embodiments, each of the first filler material joint and the second filler material joint comprises a brazed joint and/or a welded joint.

In some embodiments, the fuel delivery pipe unit is connected to the fuel rail (4) by a third filler material joint.

In some embodiments, the third filler material joint comprises a brazed joint and/or a welded joint.

In some embodiments, the connecting element (6) is a sheet-metal part.

As another example, some embodiments may include a method of assembling a fuel rail assembly (20) for a combustion engine, the fuel rail assembly comprising a fuel delivery pipe unit comprising an injector cup (3) for receiving a fuel inlet portion of a fuel injector, a pipe (2) being hydraulically coupled to the injector cup (3), and at least one fixation unit for fixing the fuel delivery pipe unit to the combustion engine. The method may include: hydraulically coupling the pipe (2) to an elongated tubular fuel rail (4) for hydraulically coupling the fuel delivery pipe unit to the fuel rail (4) and fixedly connecting the pipe (2) to the injector cup (3). In some embodiments, the method further includes manufacturing the fixing unit. Manufacturing the fixing unit comprises providing a connecting element (6) and a bracket element (1), positioning the connecting element (6) next to a predetermined pipe unit portion so that it is axially and rotatably displaceable relative to the pipe (2) and the injector cup (3) with respect to a longitudinal axis of the pipe (2), positioning the bracket element (1) next to a predetermined connecting element portion, so that it is laterally displaceable with respect to the connecting element (6), moving the bracket element (1) for adjusting its radial distance from the pipe (2) and the injector cup (3), fixedly connecting the connecting element (6) to the predetermined pipe unit portion by a first filler material joint, and fixedly connecting the bracket element to the predetermined connecting element portion by a second filler material joint.

In some embodiments, the predetermined pipe unit portion is a portion of the pipe (2) or a portion of the injector cup (3).

In some embodiments, the method may include hydraulically coupling the pipe (2) to the fuel rail (4) comprises fixedly connecting the pipe (2) to the fuel rail (4) by a third filler material joint.

In some embodiments, the method may include fixedly connecting the pipe (2) to the injector cup (3) comprises connecting the pipe (2) to the injector cup (3) by a further filler material joint.

In some embodiments, the method may include inserting a fuel inlet portion of a fuel injector into the injector cup (3).

In some embodiments, the method may include inserting a fixation bolt into a through hole of the bracket element (1) and fixing the bracket element (1) to the combustion engine with the fixation bolt.

In some embodiments, forming the filler material joints comprises manufacturing a brazed and/or welded connection.

In some embodiments, the bracket element (1) is produced using a method selected from a group consisting of extrusion, machining, casting, forging, and cold forming.

In some embodiments, the connecting element (6) is produced using a method selected from a group consisting of machining, stamping, and forging.

### BRIEF DESCRIPTION OF THE DRAWINGS

Embodiments or features only described in connection with one aspect of the present disclosure—e.g. the fuel rail configuration, the fuel rail assembly or the method—are also suitable for the other aspects. Further advantages, embodiments, and developments of the fuel rail configuration, the fuel rail assembly and the method will become apparent from the following exemplary embodiments which are described in connection with schematic figures.

In the figures:

FIG. 1 illustrates a longitudinal sectional view of a fuel rail assembly for an internal combustion engine according to teachings of the present disclosure,

FIG. 2 illustrates a side view of the fuel rail assembly of FIG. 1,

FIG. 3 illustrates a top view of the fuel rail assembly of FIG. 1,

FIG. 4 illustrates a perspective view of the fuel rail assembly of FIG. 1,

FIG. 5 illustrates different possible rotational positions of a connecting element of a fixation unit of the fuel rail assembly of FIG. 1,

FIG. 6 illustrates different possible positions of a bracket element of the fixation unit of the fuel rail assembly of FIG. 1, and

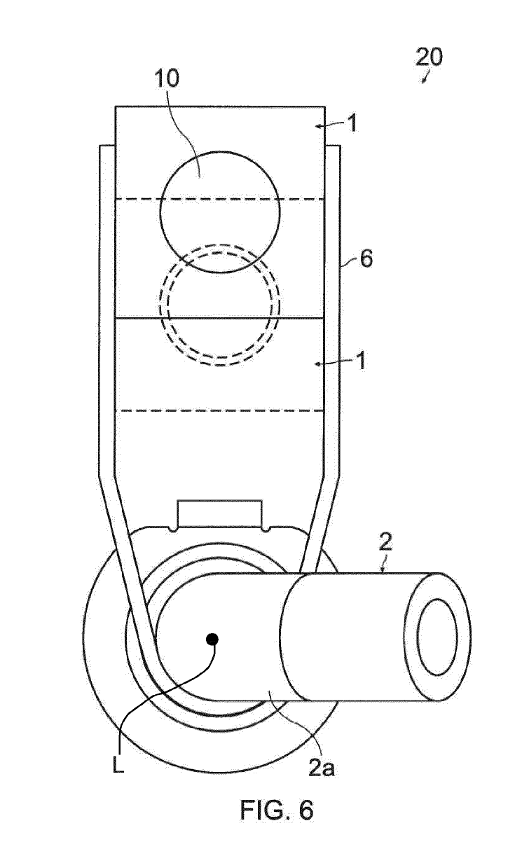

FIG. 7 illustrates a perspective view of a fuel rail assembly according to teachings of the present disclosure.

In the following description, details are provided to describe embodiments of the application. It shall be apparent to one skilled in the art, however, that the embodiments may be practiced without such details.

### DETAILED DESCRIPTION

The teachings of the present disclosure describe fuel rail configurations arranged for assembly to form a fuel rail assembly.

The combustion engine may burn fuel for producing mechanical power. In some embodiments, fuel is delivered to one or more combustion chambers of the combustion engine by fuel injectors. Many combustion engines have three, four, or six combustion chambers. The fuel injectors may inject fuel directly into the combustion chambers.

In some embodiments, the fuel rail configuration includes an elongated tubular fuel rail and one or more fuel delivery pipe units. For example, the fuel delivery configuration has a total of three or more fuel delivery pipe units in some embodiments, e.g. a total of four fuel delivery pipe units in case of a four cylinder engine. Only one of the fuel delivery pipe units is described in detail in the following. In the case of a plurality of fuel delivery pipe units, all of them may be of identical type.

In some embodiments, the fuel delivery pipe unit is hydraulically coupled to the fuel rail. This coupling allows fuel to flow from the fuel rail to the fuel delivery pipe unit under pressure. The fuel delivery pipe unit includes a pipe, an injector cup, and a fixation unit. One end of the pipe is hydraulically coupled to the fuel rail while another end of the pipe is hydraulically coupled to the injector cup. The pipe acts a passageway for allowing fuel to flow from the fuel rail to the injector cup. The injector cup is shaped and arranged for receiving a fuel inlet portion of one of the fuel injectors. The fuel injector acts to receive fuel with its fuel inlet portion from the fuel rail through the pipe and the injector cup for injecting the received fuel into a combustion chamber of the combustion engine.

In some embodiments, the fixation unit fixes the fuel delivery pipe unit to the combustion engine. It secures the fuel delivery pipe unit to the combustion engine such that the fuel delivery pipe unit does not move with respect to the combustion engine, especially during delivery of fuel from the delivery pipe unit to the combustion engine under high pressure.

In some embodiments, the fixation unit comprises a connecting element and a bracket element. The connecting element is axially movable with respect to the pipe and the injector cup of the fuel delivery pipe unit. The connecting element is also rotatably movable with respect to the pipe and the injector cup of the fuel delivery pipe unit. To put it differently, the connecting element is axially displaceable and rotatable with respect to a longitudinal axis of the pipe—the longitudinal axis of the pipe coinciding with a longitudinal axis of the injector cup—independently from the pipe and the injector cup. In other words, the connecting element can then move along a surface of the fuel delivery pipe unit for placing the connecting element at different axial positions relative to the pipe and the injector cup. The connecting element can also rotate about an axis of the fuel delivery pipe unit for placing the connecting element at different angles with respect to the pipe and the injector cup.

In some embodiments, the connecting element is fixedly connected to a predetermined pipe unit portion by a first filler material joint. The predetermined pipe unit portion may expediently be selected from a plurality of portions of the fuel delivery pipe unit. In some embodiments, the predetermined pipe unit portion is a predetermined portion of the pipe of the fuel delivery pipe unit. In some embodiments, connecting element is preferably placed next to the pipe. To put it differently, the connecting element preferably adjoins the pipe. In another embodiment, the connecting element is fixedly connected to a predetermined portion of the injector cup of the fuel delivery pipe unit.

In some embodiments, the connecting element can move linearly along the pipe and rotate around the pipe in order to place the connecting element in different positions with respect to the predetermined pipe unit portion. This allows the connection element to be later connected and to be fixed to the predetermined pipe unit portion by the first filler material joint. Movement of the connecting element is possible while the pipe and the injector cup may already be fixed to one another.

In some embodiments, the bracket element is laterally movable with respect to the connecting element. To put it differently, the bracket element may be spaced apart from the pipe and displaceable towards and/or away from the pipe, in a radial direction with respect to the longitudinal axis of the pipe.

In some embodiments, the bracket element is fixedly connected to a predetermined connecting element portion by a second filler material joint. The predetermined connecting element portion may be selected from a plurality of portions of the connecting element. Put differently, the bracket element is intended for moving with respect to the connecting element for placing the bracket next to a predetermined connecting element portion, so that the radial distance—i.e. the distance in direction perpendicular to the longitudinal axis—of the bracket element from the pipe and from the injector cup is adjustable. This then allows the bracket element to be fixedly connected later to the predetermined connecting element portion by the second filler material joint.

In some embodiments, the connecting element is a sheet-metal part. Such parts are particularly cost-efficient. In some embodiments, the connection element has a U-shape in top view along the longitudinal axis, the pipe positioned adjacent to the closed end of the U-shape and the bracket element follows the pipe in direction from the closed end towards the open end of the U-shape. The pipe may adjoin the closed end of the U-shape.

In some embodiments, the bracket element includes a through hole for receiving a fixation bolt, such as a screw or a rivet. The fixation bolt fixes the bracket element to the engine. The predetermined pipe unit portion and the predetermined connecting element portion are selected to allow the fuel rail configuration to be fixed to a selected combustion engine.

In some embodiments, the fuel delivery pipe unit and the connecting element with the bracket unit are fixed to one another by filler material joints. The fixation bolt then fixes the bracket element together with the connecting element and with the fuel delivery pipe unit to the selected combustion engine.

In some embodiments, a fuel rail assembly comprises the fuel rail configuration and the filler material joints. The axial and rotational movability of the connecting element with respect to the pipe and the lateral displaceability of the bracket element with respect to the connecting element is solely prevented by the first and second filler material joints, respectively.

In other words, the fuel rail assembly may include a fuel rail assembly for a combustion engine. It comprises the elongated tubular fuel rail and the at least one fuel delivery pipe unit which is hydraulically coupled to the fuel rail. The fuel delivery pipe unit comprises the injector cup for receiving the fuel inlet portion of a respective one of the fuel injectors, the pipe which is hydraulically coupled to the injector cup and to the fuel rail, and the at least one fixation unit for fixing the fuel delivery pipe unit to the combustion engine.

In some embodiments, the fixation unit comprises the connecting element which is fixedly connected to the predetermined pipe unit portion by the first filler material joint and, absent the first filler material joint, is axially and rotatably movable relative to the pipe and the injector cup with respect to the longitudinal axis of the pipe. The fixation unit further comprises the bracket element with the through hole for receiving the fixation bolt which is provided for fixing the bracket element to the engine. The bracket element is fixedly connected to the predetermined connecting element portion by the second filler material joint and, absent the second filler material joint, is laterally movable with respect to the connecting element for adjusting its radial distance from the pipe and the injector cup.

In some embodiments, the fuel rail configuration and the fuel rail assembly can be used for different engine types, which often have different shapes and dimensions. The same fuel rail configuration can be used for the different engine types, thereby saving cost and development time. Adaption for different engine shapes is simply achievable by changing the distance of the through hole of the bracket element from the pipe and from the injector cup by laterally moving the bracket element on the connection element and/or by axially shifting the connection element along the pipe and/or by rotating the connection element along the pipe. Large variations of the position of the through hole of the bracket element with respect to the injector cup are achievable in this way. Positioning of the bracket element in radial, circumferential and axial directions is possible independently from the pipe as well as the injector cup. This may be of particular importance when the injector cup comprises indexing features, e.g. for securing the corresponding fuel injector in a predetermined angular orientation with respect to the injector cup.

In some embodiments, the fuel delivery pipe unit may be fixedly connected to the fuel rail by a third filler material joint. This may enable easy production. Other types of attachment are also possible.

One or more of the above mentioned filler material joints can include a brazed joint. The brazed joint is formed using a filler material for joining two or more metal portions. During this joining of the metal portions, the metal portions are in a solid state while the filler material is in a liquid state.

In some embodiments, one or more of the filler material joints can include a welded joint. The welded joint is formed using a filler material for joining two or more metal portions. During this joining of the metal portions, the metal portions, and the filler material joint are in a liquid state. In some embodiments, the filler material joints are produced by forming a spot-welded pre-connection and subsequently forming a fluid-tight brazed connection. By means of the pre-connection, the individual parts are securely held in place while the brazed connection is formed.

In some embodiments, the bracket element can be produced using a method selected from a group consisting of extrusion, machining, casting, forging, and cold forming. The connecting element can be produced using a method selected from a group consisting of machining, stamping, and forging.

In some embodiments, a method may include coupling the pipe hydraulically to the elongated tubular fuel rail. In some embodiments, the method comprises manufacturing the fixing unit. In some embodiments, the connecting element and the bracket element may be provided. The connecting element is positioned next to the predetermined pipe unit portion so that it is axially and rotatably displaceable relative to the pipe and the injector cup with respect to the longitudinal axis of the pipe. The bracket element is positioned next to the predetermined connecting element portion so that it is laterally displaceable with respect to the connecting element.

In some embodiments, a step of adjusting is performed. In particular, the bracket element is moved—in particular relative to the connecting element, for example laterally—for adjusting its radial distance from the pipe and the injector cup.

In some embodiments, the step of adjusting may comprise selecting the predetermined connecting element portion from a plurality of portions of the connecting element. Further the adjustment step may include a step of selecting the predetermined pipe unit portion from a plurality of portions of the fuel delivery pipe unit. The connecting element may then be axially moved and/or rotatably moved for placing the connecting element next to the predetermined pipe unit portion. In some embodiments, the bracket element may be laterally moved for placing the bracket element next to the predetermined connecting element portion.

In some embodiments, the method comprises performing a connecting step, wherein the connecting step comprises fixedly connecting the connecting element to the predetermined pipe unit portion by a first filler material joint and fixedly connecting the bracket element to the predetermined connecting element portion by a second filler material joint.

The various methods allow the same fuel rail configuration to be connected to different engine types. The methods can include different further steps, in particular for providing additional advantages.

In some embodiments, the connecting element is fixedly connected to different components of the fuel delivery pipe unit. In some embodiments, the connecting element is fixedly connected to a portion of a pipe of the fuel delivery pipe unit, wherein the pipe is hydraulically coupled to the fuel rail. In some embodiments, the connecting element is fixedly connected to a portion of an injector cup, wherein the injector cup is hydraulically coupled to the pipe, which is hydraulically coupled to the fuel rail. The pipe may be connected to the fuel rail by the third filler material joint.

In some embodiments, the method may comprise a step of fixedly connecting the pipe to the injector cup. The step may comprise selecting an angular and axial position of the bracket element relative to the injector cup from a plurality of angular and axial positions. The pipe may be fixedly connected to the injector cup by a further filler material joint. All filler material joints may be produced at the same time in a brazing oven.

In some embodiments, the method comprises inserting the fuel inlet portion of one of the fuel injectors into the injector cup of the fuel delivery pipe. In this case, the method may be a method for producing a fuel delivery assembly which comprises the fuel rail assembly and the fuel injectors.

In some embodiments, the method comprises inserting the fixation bolt into the through hole of the bracket element and preferably fixing the bracket element to the combustion engine with the fixation bolt. In this case, the method is in particular a method for producing an engine assembly comprising the fuel delivery assembly. The engine assembly may further comprise the engine or at least a cylinder head of the engine in which the fixation bolt is received.

The first, the second, the third, and/or the further filler material joints can be formed by involving a brazing step. Forming of the first, the second, the third, and/or the further filler material joints can additionally or alternatively involve a welding step. In some embodiments, the injector cup may be fixedly connected to the pipe before or after fixing the position of the connecting element relative to the predetermined pipe unit portion and before or after fixing the position of the bracket element relative to the predetermined connecting element portion, in particular by means of respective welding steps which may in particular form spot welds.

In some embodiments, the present disclosure provides a brazed fuel rail assembly. The fuel rail assembly includes a fuel rail, a plurality of fuel delivery lines, and a plurality of fixation units. A fuel delivery line and a fixation unit together correspond to the above-mentioned pipe unit. The fuel delivery lines are connected to the fuel rail by brazed joints. The fuel delivery lines are also connected to the respective fixation units by brazed joints. The brazed joint is formed using a filler material for joining two or more metal portions. During the joining of the metal portions, the metal portions are in a solid state while the filler material is in a liquid state.

In some embodiments, each fuel delivery line includes a pipe—sometimes also denoted as a drop pipe—and an injector cup. One end of the drop pipe is attached to the fuel rail while another end of the drop pipe is attached to the injector cup or in one piece with the injector cup. The injector cup is arranged for facing a cylinder head of a combustion engine. The drop pipes are connected to the fuel rail by brazed joints. The drop pipes may also be connected to the corresponding injector cups by brazed joints.

In some embodiments, each fixation unit includes a connecting element, a sliding bracket—i.e. the bracket element which is slideable along the connecting element before fixing with the filler material joint—and in particular a fixation bolt.

In some embodiments, the connecting element is placed next to a corresponding drop pipe. The connecting element can be placed at different angles with respect to the drop pipe. Moreover, the connecting element can also be placed at different heights or levels with respect to the drop pipe. The sliding bracket is placed next to the connecting element, wherein the sliding bracket can move or slide with respect to the connecting element.

In some embodiments, the method includes a step of each connecting element being placed at a predetermined angle and at a predetermined height with respect to the corresponding drop pipe. Each sliding bracket is then placed at a predetermined position with respect to the corresponding connecting element. The predetermined angle and the predetermined height of the connecting element as well as the predetermined position of the sliding bracket are selected such that the assembled fuel rail configuration is suitable for connecting the selected engine.

The connecting element is then connected to the corresponding drop pipe by a brazed joint. The sliding bracket is connected to the corresponding connecting element by a brazed joint. The fixation bolt is later inserted into a through hole of the corresponding sliding bracket and it is screwed into a corresponding fixation boss or protruding part of a cylinder head of the selected engine for fixing the sliding bracket to the cylinder head. In some embodiments, the connecting element is connected to the corresponding injector cup, in particular by a brazed joint, instead of being connected to the corresponding drop pipe. Parts of the same fuel rail configuration can be altered for adapting to different configurations and different dimensions of various engines.

In some embodiments, the sliding bracket can have two flat parallel faces with different shapes, such square, rectangular, or trapezoidal. These faces face towards and adjoin the connecting element. The position of the sliding bracket and the position of a through hole inside the sliding bracket can also be changed for adapting to different engines, especially with different distances between its injector axis and its fixing point axis. The sliding bracket can also include two symmetric or asymmetric brackets.

In some embodiments, the connecting element can have a prismatic shape portion, e.g. a portion which is V-shaped in top view along the longitudinal axis. The connecting element can also have a cylindrical part, wherein the cylindrical part is connected to the pipe by a brazed connection that extends, for example 180° around the pipe.

In some embodiments, the connecting element and/or the bracket element can also have an inclined wall portion to allow for attaching to an engine in which its fixing point axis is inclined with respect to its injector axis, i.e. in particular the longitudinal axis. The sliding bracket and the connecting element can also have different thickness for mounting with different types of engine that have different dimensions. Contact surfaces between the sliding bracket and the connecting element can be changed according to types of engine. The sliding bracket and the connecting elements can be produced using different methods. The sliding bracket can be produced using extrusion, machining, casting, forging, or cold forming. The connecting element can also be produced using sheet metal, machining, stamping, or forging.

Some parts of the embodiment have similar elements. The similar elements may have the same names or similar part numbers. The description of one similar element also applies by reference to another similar elements, where appropriate, thereby reducing repetition of text without limiting the disclosure.

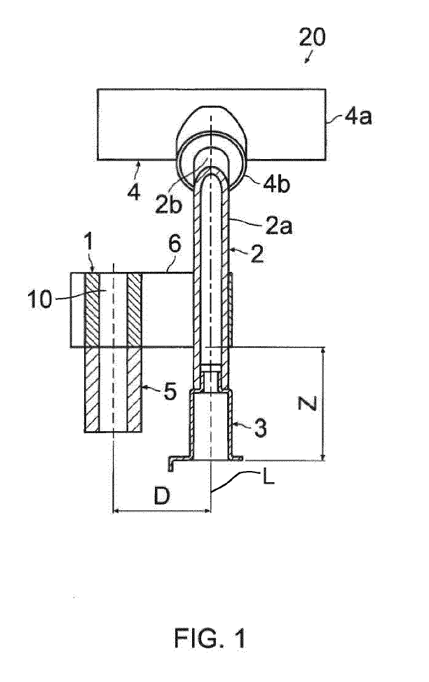

FIGS. 1, 2, and 4 show a fuel rail assembly 20 for an internal combustion engine. Only a fixation boss 5 of the combustion engine is shown in the FIG. 1.

The fuel rail assembly 20 includes a fuel rail 4, a plurality of pipe units with a plurality of corresponding fixation units. The fuel rail 4 is connected to the pipe units. The fixation units are adapted for fixing the pipe units to the combustion engine.

A first end of each pipe unit is hydraulically coupled to the fuel rail 4 such that a liquid fuel, such as gasoline, can flow from the fuel rail 4 to the respective pipe unit. The first end is also fixedly connected to the fuel rail 4 by a brazed joint. In other words, the brazed joint fixes the respective pipe unit mechanically to the fuel rail 4. A second end of the pipe unit is attached to a respective fuel injector (not shown in the figures).

The pipe units and the fuel rail 4 are made from metal. The brazed joint is formed by using a filler material for joining two or more metal portions. The filler material has a melting temperature that is lower than melting temperatures of the metal portions. The filler material melting temperature is rather high and is often in a range of about 470° C. to about 1190° C. Because of this, during the joining of the metal portions, the metal portions are in a solid state while the filler material is in a liquid state.

In some embodiments, the metal that is used to produce the pipe units and the fuel rail 4 comprises stainless steel, in particular, steel having the American Iron and Steel Institute (AISI) type 304 or a variant of characteristics of the AISI 304 type steel. In a general sense, this embodiment can work with different types of metal.

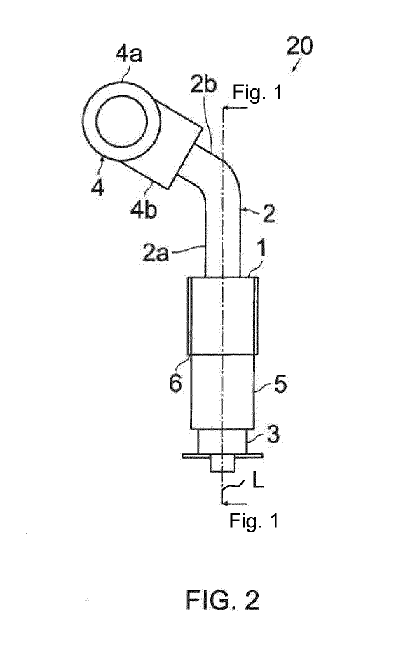

In detail, as seen in FIGS. 1 and 2, the fuel rail 4 includes a tube 4a and a plurality of fuel outlet ports 4b. The outlet ports 4b are inserted into and/or laterally surround holes of the tube 4a. The outlet ports 4b are also fixedly connected to the tube 4a by brazed joints. Referring to the pipe unit, it includes a drop pipe 2 and an injector cup 3.

The drop pipe 2 includes a straight portion 2a and a bend portion 2b to form a substantially elongated body. A first end part of the bend portion is integrally connected to a first end part of the straight portion 2a. A second end part of the bend portion of the drop pipe 2 is hydraulically coupled to the fuel rail 4. This end part is also inserted into the outlet port 4b of the fuel rail 4 and it is fixedly connected to the outlet port 4b by a brazed joint.

A second end part of the straight portion 2a of the drop pipe 2 is hydraulically coupled to the injector cup 3. This end part is inserted into the injector cup 3—or vice versa—and it is fixedly connected to the injector cup 3 by a brazed joint. The injector cup 3 is arranged for facing a cylinder head of the combustion engine. A fuel inlet portion of the respective fuel injector is received in the injector cup 3 in operation of the engine. The injector cup 3 may be provided with an indexing feature for securing the fuel injector in a predetermined angular position with respect to the injector cup.

The cylinder head is intended for placing next to a cylinder block of the combustion. The cylinder block includes large holes, wherein cylinders are placed in the holes. The cylinder head covers these holes such that space between the cylinder head and the respective cylinder form a combustion chamber.

Referring to the fixation units, each fixation unit includes a movable connecting element 6 with a bracket element 1. The connecting element 6 and the bracket element 1 can be placed at different positions for adapting to different dimensions and shapes of different engines. The bracket 1 includes a through hole 10 that is adapted for receiving a fixation bolt, such as a screw.

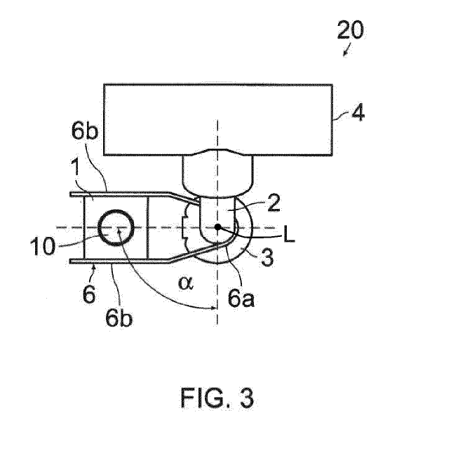

As better seen in FIG. 3, the connecting element 6 is U-shaped in top view along a longitudinal axis L of the straight portion 2a of the pipe 2. In other words, it includes a central bend portion 6a and two parallel arm portions 6b, which are integrally connected to the bend portion 6a.

The bend portion 6a of the connecting element 6 is placed next to the drop pipe 2 and it contacts the drop pipe 2, wherein the bend portion 6a partially encloses the drop pipe 2.

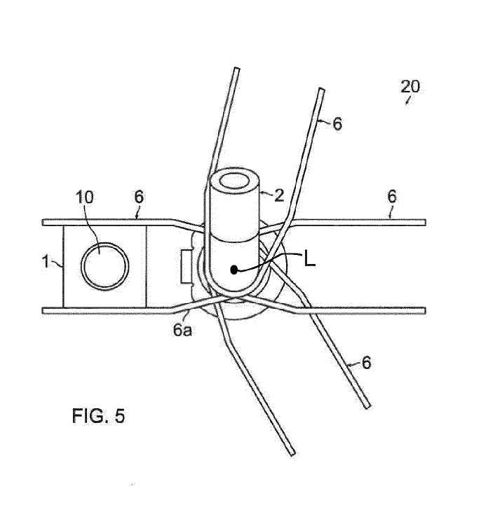

As better seen in FIG. 5, the bend portion 6a can rotate about the drop pipe 2 for placing the connecting element 6 at different angular positions with respect to the drop pipe 2 and the injector cup 3 during manufacturing of the fuel rail assembly 20.

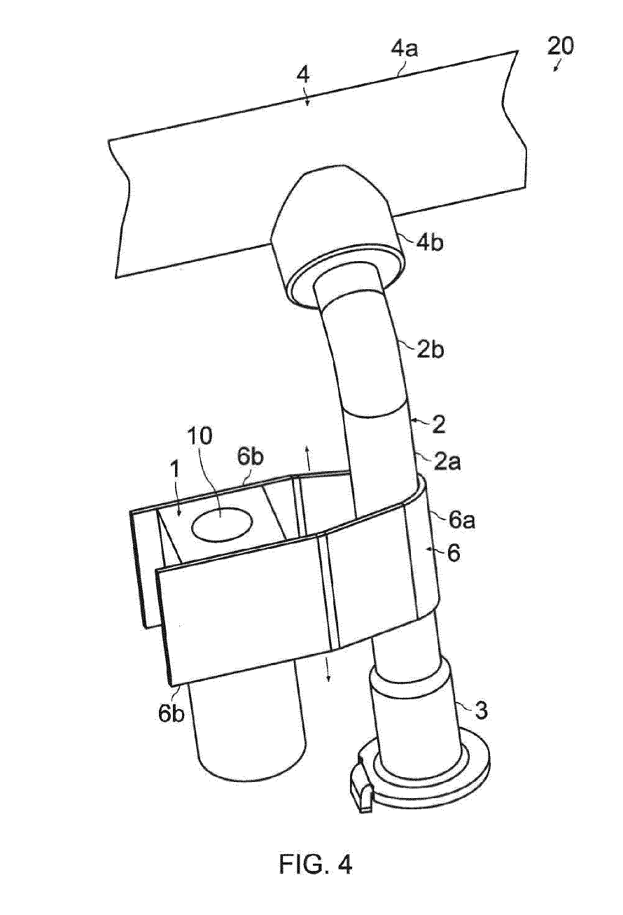

Moreover, during manufacturing of the fuel rail assembly 20, the bend portion 6a can also move linearly in a direction that is parallel to an axis of the straight portion 2a of the drop pipe 2 for placing bend portion 6a next to different parts of the straight portion 2a of the drop pipe 2. This is indicated by arrows in FIG. 4. In effect, the connecting element 6 can be placed at different heights or levels with respect to the longitudinal axis L of the straight portion 2a of the drop pipe 2.

Since the pipe 2, the injector cup 3 and the connecting element 6 are separate parts, also an axial and rotational position of the connecting element 6 relative to the injector cup 3 is selectable in this way, in particular for adapting the fuel rail assembly to different engine environments.

The arm portions 6b enclose the bracket element 1 and they contact or touch outer edges of the bracket element 1. During manufacturing the fuel rail assembly 20, the bracket element 1 can also move laterally—i.e. radially towards and away from the straight portion 2a—with respect to the straight portion 2a of the drop pipe 2 for placing the bracket element 1 to different parts of the arm portions 6b. In this way, a radial distance of the bracket element 1 from the pipe 2 and the injector cup 3 is adjustable for adapting the fuel rail assembly to different engine environments.

The connecting element 6 and the bracket element 1 are made from metal, thereby allowing them to the later fixedly connected by brazed joints during manufacturing the fuel rail assembly 20. The material of the connecting element 6 also allows the connecting element 6 to be fixedly connected to the drop pipe 2 by brazed joints during manufacturing the fuel rail assembly 20. The metal that is used to produce the connecting element 6 and the drop pipe 2 and the bracket element 1 may comprise stainless steel. In a general sense, this embodiment can work with different types of metal.

Different methods can be employed for producing the bracket element and the connecting element 6. The sliding bracket 1 can be produced using extrusion, machining, casting, forging, or cold forming. The connecting element 6 can be produced using machining, stamping, or forging. Preferably, the connecting element 6 is a sheet metal part.

In use, the fuel rail assembly 20 provides liquid fuel to the combustion engine under a high pressure. The fuel rail 4 acts as a reservoir for receiving the liquid fuel. The pipe units transfer the fuel from the fuel rail 4 to the fuel injectors. The fixation units secure the pipe units to the combustion engine such that the pipe units do not move substantially.

In detail, the tube 4a provides a space for storing the liquid fuel under high pressure. Each outlet port 4b acts as an opening to release fuel from the tube 4a to the respective drop pipe 2. Each drop pipe 2 acts as a delivery line for transferring the fuel from the corresponding outlet port 4b to the corresponding injector cup 3. Each injector cup 3 transfers fuel from the corresponding drop pipe 2 to the fuel inlet portion of the respective injector. Each injector dispenses the fuel received from the respective injector cup 3 into a corresponding combustion chamber of the combustion engine.

The brazed joints act to fix the tube 4a to the outlet ports 4b such the outlet ports 4b are mechanically and fluid-tightly secured to the tube 4a, especially during delivery of fuel under high pressure from the tube 4a to the outlet ports 4b. The high pressure can cause the fuel to leak from a connection between the tube 4a and the respective outlet port 4b, if the tube 4a is not fixed to the respective outlet port 4b.

Similarly, the brazed joints also act to mechanically fix and fluid-tightly couple the outlet ports 4b to the corresponding drop pipes 2. The brazed joints also serve to mechanically fix and fluid-tightly couple the drop pipes 2 to the corresponding injector cups 3. Only the respective brazed joints (not shown in the figures) inhibit axial and rotational displacement of the connecting element 6 with respect to the pipe 2 and lateral displacement of the bracket element 1 with respect to the connecting element 6.

The brazed joints are formed using a filler material for joining two or more metal portions. The filler material has a melting temperature that is lower than melting temperatures of the metal portions. The filler material melting temperature is high and is often in the range of about 470 to about 1190 degree Celsius. Because of this, during the joining of the metal portions, the metal portions are in a solid state while the filler material is in a liquid state.

Referring to the fixation units, the bend portion 6a of the connecting element 6 can be placed at different angles with respect to the drop pipe 2. The bend portion 6a of the connecting element 6 can also be placed next to different portions of the drop pipe 2, wherein the bend portion 6a also contacts or touches these portions. The bracket element 1 can be placed next to different portions of the connecting element 6.

The above-mentioned various placements allow the fixation units to be configured such that the same fuel rail assembly 20 can be adjusted for connecting to different combustion engines with different dimensions and with different shapes.

A method of assembling of the fuel rail assembly 20 for connecting to a selected combustion engine is described below. In some embodiments, the assembly includes an adjustment step, which is followed by a brazing step.

Referring to the adjustment step, it includes a step of rotating each connecting element 6 about the corresponding drop pipe 2 to place the connecting element 6 at a predetermined angular position, as shown in FIG. 3.

The connecting element is then moved axially with respect to the straight portion 2a of the corresponding drop pipe 2 for placing the connecting element next to a predetermined part of the drop pipe 2.

The bracket element 1 is later moved laterally with respect to the straight portion 2a for placing the sliding bracket 1 next to a predetermined part of the connecting element 6.

The predetermined angular position, the predetermined part of the drop pipe 2, the predetermined part of the connecting element 6 are chosen such that the assembled fuel rail assembly 20 can be attached to the selected combustion engine.

Referring to the brazing step, it includes fixedly connecting the connecting element 6 to the drop pipe 2 by brazing wherein a brazed joint fixes the connecting element 6 to the drop pipe 2.

The bracket element 1 is also fixedly connected to the connecting element 6 by brazing wherein a brazed joint fixes the bracket element 1 to the connecting element 6.

The fixation bolt is then inserted into the through hole 10 of the sliding bracket 1 and it is screwed into the fixation boss 5 of the cylinder head for fixing the sliding bracket 1 to the cylinder head, as shown in FIG. 1. The fixation boss 5 is also called a protruding part.

This fixing, in turn, also fixes the connecting element 6 and the drop pipe 2 to the cylinder head.

In a different embodiment, the connecting element 6 is connected to the injector cup 3, instead of being connected to the drop pipe 2, by a brazed joint.

In a general sense, the brazed joint can be replaced by a welded joint.

The welded joint is formed using a filler material for joining two or more metal portions. During the joining of the metal portions, the metal portions, and the filler material joint is in a liquid state.

In summary, the embodiment provides a fuel rail assembly 20 that comprises adaptable fixation parts for adjusting to different engines.

During production of the fuel rail assembly 20, fixation parts of the fuel rail assembly 20 are adapted according to a configuration of a selected engine. The adaption is done such that these parts can be attached to a fixing point of the selected engine. After this, these parts are fixedly connected together by brazing, wherein brazed joints fixes the adjacent parts to each other.

Different engines often have different fixing points with different positions. The same fuel rail assembly 20 can be adapted to these different positions of the fixing points of these different engines. This is different from other fuel rail assemblies, wherein a dedicated fuel rail assembly is provided for each engine. A separate development effort and additional expense hence need to be provided for each fuel rail assembly.

Different variants of the fuel rail assembly 20 are possible.

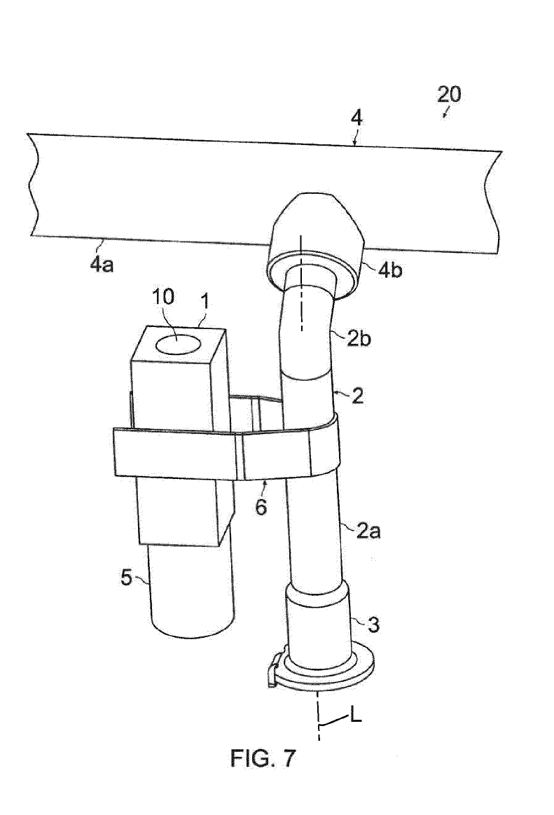

FIG. 7 shows another fuel rail assembly 20 which corresponds in general to the fuel rail assembly of the first embodiment. However, it comprises an axially elongated bracket element 1. The bracket element 1 projects longitudinally from the connecting element 6 in both axial directions with respect to the longitudinal axis L of the straight portion 2a of the pipe 2.

Although the above description contains much specificity, this should not be construed as limiting the scope of the embodiments but merely providing illustration of the foreseeable embodiments. The above stated advantages of the embodiments should not be construed especially as limiting the scope of the embodiments but merely to explain possible achievements if the described embodiments are put into practice. Thus, the scope of the embodiments should be determined by the claims and their equivalents, rather than by the examples given.

What is claimed is:

1. A fuel rail assembly for an combustion engine, the fuel rail assembly comprising:
an elongated tubular fuel rail;
a fuel delivery pipe unit hydraulically coupled to the fuel rail;
the fuel delivery pipe unit comprising an injector cup for receiving a fuel inlet portion of a fuel injector, a pipe hydraulically coupled to the injector cup and to the fuel rail, and at least one fixation unit for fixing the fuel delivery pipe unit to the combustion engine;
wherein the fixation unit comprises a connecting element fixedly connected to a predetermined pipe unit portion by a first filler material joint;
the connecting element, absent the first filler material joint, is axially and rotatably movable relative to the pipe and the injector cup with respect to a longitudinal axis of the pipe;
the fixation unit includes a bracket element comprising a through hole for receiving a fixation bolt which is provided for fixing the bracket element to the engine;
wherein the bracket element is fixedly connected to a predetermined connecting element portion by a second filler material joint; and
the bracket element, absent the second filler material joint, is laterally movable with respect to the connecting element for adjusting its radial distance from the pipe and the injector cup.

2. The fuel rail assembly according to claim 1, wherein each of the first filler material joint and the second filler material joint comprises a brazed joint and/or a welded joint.

3. The fuel rail assembly according to claim 1, wherein the fuel delivery pipe unit is connected to the fuel rail by a third filler material joint.

4. The fuel rail assembly according to claim 3, wherein the third filler material joint comprises a brazed joint and/or a welded joint.

5. The fuel rail assembly according to claim 1, wherein the connecting element comprises a sheet-metal part.

6. A method of assembling a fuel rail assembly for a combustion engine, the fuel rail assembly comprising a fuel delivery pipe unit with an injector cup for receiving a fuel inlet portion of a fuel injector, a pipe hydraulically coupled to the injector cup, and a fixation unit for fixing the fuel delivery pipe unit to the combustion engine, the method comprising:
hydraulically coupling the pipe to an elongated tubular fuel rail; and
fixedly connecting the pipe to the injector cup;
positioning a connecting element next to a predetermined pipe unit portion so that it is axially and rotatably displaceable relative to the pipe and the injector cup with respect to a longitudinal axis of the pipe;
positioning a bracket element next to a predetermined connecting element portion so that it is laterally displaceable with respect to the connecting element;
moving the bracket element for adjusting its radial distance from the pipe and the injector cup;
fixedly connecting the connecting element to the predetermined pipe unit portion by a first filler material joint; and
fixedly connecting the bracket element to the predetermined connecting element portion by a second filler material joint.

7. The method according to claim 6, wherein the predetermined pipe unit portion is a portion of the pipe or a portion of the injector cup.

8. The method according to claim 6, wherein hydraulically coupling the pipe to the fuel rail comprises fixedly connecting the pipe to the fuel rail by a third filler material joint.

9. The method according to claim 6, wherein fixedly connecting the pipe to the injector cup comprises connecting the pipe to the injector cup by a further filler material joint.

10. The method according to claim 6, further comprising inserting a fuel inlet portion of a fuel injector into the injector cup.

11. The method according to claim 6, further comprising inserting a fixation bolt into a through hole of the bracket element and fixing the bracket element to the combustion engine with the fixation bolt.

12. The method according to claim 6, wherein forming the filler material joints comprises manufacturing a brazed and/or welded connection.

13. The method according to claim 6, wherein the bracket element is produced using a method selected from a group consisting of extrusion, machining, casting, forging, and cold forming.

14. The method according to claim 6, wherein the connecting element is produced using a method selected from a group consisting of machining, stamping, and forging.
